(19) United States
(12) Patent Application Publication
(10) Pub. No.: US 2017/0015942 A1
(43) Pub. Date: Jan. 19, 2017

(54) METHOD OF MANUAL DISHWASHING

(71) Applicant: The Procter & Gamble Company, Cincinnati, OH (US)

(72) Inventors: Claire Emeline IGLESIAS, Etterbeek (BE); Nuray YALDIZKAYA, Gent (BE)

(21) Appl. No.: 15/202,787

(22) Filed: Jul. 6, 2016

(30) Foreign Application Priority Data
Jul. 16, 2015 (EP) 15177147.4

(51) Int. Cl. C11D 1/75; C11D 3/37; C11D 1/29

(52) U.S. Cl. CPC C11D 1/75; C11D 1/29; C11D 3/3723

(57) ABSTRACT

A method of washing dishware including the steps of: i) delivering a detergent composition in its neat form onto the dishware or a cleaning implement; ii) cleaning the dishware with the detergent composition in the presence of water; and iii) optionally rinsing the dishware.

### FIELD OF THE INVENTION

The present invention relates to a method of manually washing dishware using a detergent composition comprising anionic surfactant, amine oxide surfactant including a low-cut amine oxide and an alkoxylated polyalkyleneimine. The method provides very good cleaning with very good flash suds.

### BACKGROUND OF THE INVENTION

Traditionally manual dishwashing has been performed by filling a sink with water, adding a dishwashing detergent to create a soapy solution, immersing the soiled articles in the solution, scrubbing the articles and rinsing to remove the remaining soils and remove the suds generated from the soapy solution from the washed articles. Traditionally an entire load of soiled dishware has usually been washed in one go. Nowadays some users prefer to clean articles as soon as they have finished with them rather than wait until they have a full load. This involves washing one article or a small number of articles at the time. The washing is usually performed under running water rather than in a full sink. This usually involves the use of a cleaning implement, such as a sponge. The user delivers detergent to the sponge. The cleaning should be fast and involve minimum effort from the user. The user expects the cleaning composition to foam as soon as it is delivered onto the cleaning implement.

It has been found that cleaning compositions comprising anionic surfactants and amine oxide having a low anionic surfactant amine oxide ratio are very good in terms of cleaning, even for the cleaning of polymerized grease that it is one of the soils more difficult to clean. However, compositions comprising a high level of amine oxide become very thick when contacted with a small amount of water, as the case is when the washing takes place under the tap, instead of in a full sink. The thickening of the composition is translated into a reduction of flash suds, this affects the performance of the product and the perception of the product.

In view of the above discussion, there is a need to provide a method of manual dishwashing that provides good cleaning and at the same time good flash suds.

### SUMMARY OF THE INVENTION

According to a first aspect of the invention, there is provided a method of manually washing dishware using a specific detergent composition.

The composition comprises anionic surfactant, amine oxide surfactant, including low cut amine oxide surfactant and an alkoxylated polyalkyleneimine. The composition comprises anionic surfactant and amine oxide surfactant in a ratio of from about 4:1 to about 1:1, preferably from about 3:1 to 2:1. Compositions comprising anionic surfactant and amine oxide surfactant, in particular mid-cut amine oxide surfactant, in these ratios can present a thickening upon dilution profile. A thickening upon dilution profile means that the composition takes longer to dissolve and work. Thickening upon dilution also impacts negatively on the creation of flash suds. It has been found that if part of the mid-cut amine oxide is replaced by low-cut amine oxide and an alkoxylated polyalkyleneimine is added to the composition, the composition presents a thinning upon dilution profile and generates flash suds.

The composition used in the method of the invention is sometimes herein referred to as “the composition of the invention”.

The composition preferably comprises from about 3 to about 15% by weight of the composition of amine oxide surfactant. The amine oxide surfactant is a mixture of amine oxides comprising a low-cut amine oxide and a mid-cut amine oxide.

The amine oxide of the composition of the invention comprises:
a) from about 5% to about 40%, preferably from 5% to about 30% by weight of the amine oxide of low-cut amine oxide of formula R1R2R3AO wherein R1 and R2 are selected from hydrogen, C1-C4 alkyls and mixtures thereof and wherein R3 is selected from C10 alkyls and mixtures thereof; and
b) from 60% to 95%, preferably from 70% to about 30% by weight of the amine oxide of mid-cut amine oxide of formula R4R5R6AO wherein R4 and R5 are selected from hydrogen, C1-C4 alkyls and mixtures thereof and wherein R6 is selected from C12-C16 alkyls and mixtures thereof.

The composition of the invention provides good cleaning and good flash suds. It presents benefits in terms of tough food cleaning (cooked-, baked- and burnt-on soils) and grease cleaning.

When the composition of the invention is in use, the appearance of the suds is very appealing. The suds are constituted by airy bubbles that seem to travel very quickly from the cleaning implement to the items to be cleaned. This is believed to contribute to a faster and better cleaning.

Preferably, the amphiphilic alkoxylated polyalkyleneimine is an alkoxylated polyethyleneimine polymer comprising a polyethyleneimine backbone. The polyethyleneimine backbone has from about 400 to about 5,000 weight average molecular weight. The alkoxylated polyethyleneimine polymer further comprises:

(1) one or two alkoxylation modifications per nitrogen atom by a polyalkoxylene chain having an average of about 1 to about 50 alkoxy moieties per modification, wherein the terminal alkoxy moiety of the alkoxylation modification is capped with hydrogen, a C₁-C₄ alkyl or mixtures thereof, preferably the alkoxylation modification is capped with hydrogen; or
(2) an addition of one C₁-C₄ alkyl moiety and one or two alkoxylation modifications per nitrogen atom by a polyalkoxylene chain having an average of about 1 to about 50 alkoxy moieties per modification wherein the terminal alkoxy moiety is capped with hydrogen, a C₁-C₄ alkyl or mixtures thereof, preferably the alkoxylation modification is capped with hydrogen; or
(3) a combination thereof; and
wherein the alkoxy moieties comprises ethoxy (EO) and/or propoxy (PO) and/or butoxy and wherein when the alkoxylation modification comprises EO it also comprises PO or BO.

Preferably, the weight average molecular weight per polyalkoxylene chain is from 400 to 8,000. Preferably, the weight average molecular weight of the alkoxylated polyethyleneimine is from 8,000 to 40,000.

If the polyalkoxylene chain comprises a propoxy moiety, the propoxy moiety is preferably in a terminal position.

Preferably, the polyalkoxylene chain comprises ethoxy and propoxy moieties, more preferably in a number ratio of 1:1 to 2:1.

Preferred for use herein are alkoxylated polyalkyleneimine in which the number of ethoxy moieties of a polyalkoxylene chain is from 22 to 26, the number of propoxy moieties is from 14 to 18 and preferably the polyalkoxylene chain is free of butoxy moieties. More preferred for use herein are alkoxylated polyalkyleneimine in which the number of ethoxy moieties of a polyalkoxylene chain is from 8 to 12, and the number of propoxy moieties is from 5 to 9 and preferably the polyalkoxylene chain free of butoxy moieties.

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than about 5%, more preferably less than 3% by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Compositions comprising higher levels of R7R8R9AO tend to be instable.

The composition of the invention comprises anionic surfactant, the anionic surfactant can be any anionic cleaning surfactant, preferably the anionic surfactant comprises a sulphate anionic surfactant, more preferably an alkyl sulphate and/or alkyl alkoxylated sulfate anionic surfactant, preferably an alkyl alkoxylated sulphate, preferably the alkoxylated anionic surfactant has an average alkoxylation degree of from about 0.2 to about 3, preferably from about 0.2 to about 2, most preferably from about 0.2 to about 1.0. Also preferred are branched anionic surfactants having a weight average level of branching of from about 5% to about 40%.

Preferably the composition of the invention comprises from about 1% to about 60%, preferably from about 5% to about 50%, more preferably from about 8% to about 40% by weight of the composition of total surfactant. Preferably the composition of the invention comprises from about 5% to about 40% by weight of the composition of anionic surfactant, more preferably from about 8% to about 35%, yet more preferably from about 10% to about 30%.

Preferably, the composition of the invention comprises from 0.1% to about 2%, more preferably less than 1% by weight of the composition of non-ionic surfactants. It has been found that the compositions with this low level of non-ionic surfactant can provide a more robust cleaning system.

According to the second aspect of the invention, there is provided the use of a

i) low-cut amine oxide of formula R1R2R3AO wherein R1 and R2 are selected from hydrogen, C1-C4 alkyls and mixtures thereof and wherein R3 is selected from C10 alkyls and mixtures thereof; and
ii) an amphiphilic alkoxylated polyalkyleneimine
for the generation of flash suds in a hand dishwashing composition comprising anionic surfactant and amine oxide surfactant in a ratio of from about 4:1 to about 1:1.

The elements of the method and composition of the invention described in connection with the first aspect of the invention apply mutatis mutandis to the second aspect of the invention.

For the purpose of this invention “dishware” herein includes cookware and tableware.

### BRIEF DESCRIPTION OF THE DRAWINGS

FIG. 1 and FIG. 2 depict the viscosity upon dilution of hand dishwashing compositions. FIG. 1 shows that a compositions comprising both C10 dimethyl amine oxide as well as an amphiphilic alkoxylated polyethylene imine (PEI) has more desired thinning upon dilution. FIG. 2 shows that amphiphilic alkoxylated PEI comprising EO and PO units show an improved viscosity upon dilution profile when formulated together with C10 dimethyl amine oxide.

### DETAILED DESCRIPTION OF THE INVENTION

The present invention envisages a method of manually washing dishware using a detergent composition, preferably in liquid form. The detergent composition comprises a surfactant system comprising anionic and amine oxide surfactant. It provides very good cleaning, including tough food cleaning, such as cook-, baked- and burnt-on cleaning and generates flash suds.

### Method of the Invention

The method of the invention comprises the steps of:
i) delivering a detergent composition in its neat form onto the dishware or a cleaning implement. By “neat form” is herein meant that the detergent composition is delivered onto the dishware or cleaning implement as it is, without previously diluting the composition with water.
ii) cleaning the dishware with the detergent composition in the presence of water. The water can be present by putting the dishware under a running tap, wetting the cleaning implement, etc and
iii) optionally but preferably rinsing the dishware.

### The Detergent Composition

The detergent composition is a hand dishwashing detergent, preferably in liquid form. It typically contains from 30% to 95%, preferably from 40% to 90%, more preferably from 50% to 85% by weight of the composition of a liquid carrier in which the other essential and optional components are dissolved, dispersed or suspended. One preferred component of the liquid carrier is water.

Preferably the pH of the composition is adjusted to between 3 and 14, more preferably between 4 and 13, more preferably between 6 and 12 and most preferably between 8 and 10. The pH is measured as a 10 wt % product solution in deionised water at 20° C. The pH of the composition can be adjusted using pH modifying ingredients known in the art.

The composition can comprises 1% to 60%, preferably from 5% to 50%, more preferably from 8% to 40% of total surfactant. In addition to the anionic and amine oxide surfactant the composition can optionally comprise non-ionic surfactant, zwitterionic and/or cationic surfactant.

### Viscosity

The liquid detergent composition of the present invention can be Newtonian or non-Newtonian, preferably Newtonian, with a viscosity of between 10 centipoises (cps) and 5,000 cps at 20° C. and, alternatively between 50 cps and 2,000 cps, or between 100 cps and 1,500 cps, or between 150 cps and 750 cps, alternatively combinations thereof.

Viscosity is measured with a BROOFIELD DV-E viscometer, at 20° C., spindle number 31. The following rotations per minute (rpm) should be used depending upon the viscosity: Between 300 cps to below 500 cps is at 50 rpm; between 500 cps to less than 1,000 cps is at 20 rpm; from 1,000 cps to less than 1,500 cps at 12 rpm; from 1,500 cps to less than 2,500 cps at 10 rpm; from 2,500 cps, and greater, at 5 rpm. Those viscosities below 300 cps are measured at 12 rpm with spindle number 18.

### Amine Oxide Surfactant

The amine oxide surfactant improves the cleaning and boosts the flash suds of the detergent composition. This improved cleaning and suds boosting is achieved by the combination of the anionic surfactant and amine oxide and the presence of low cut amine oxide surfactant at the claimed level and the alkoxylated polyalkyleimine.

### Low-Cut Amine Oxide

Within the meaning of the present invention “low-cut amine oxide” means an amine oxide of formula: R1R2R3AO wherein R1 and R2 are selected from hydrogen, C1-C4 alkyls and mixtures thereof and wherein R3 is selected from C10 alkyls and mixtures thereof.

### Mid-Cut Amine Oxide

Within the meaning of the present invention “mid-cut amine oxide” means an amine oxide of formula: R4R5R6AO wherein R4 and R5 are selected from hydrogen, C1-C4 alkyls and mixtures thereof and wherein R6 is selected from C12-C16 alkyls and mixtures thereof.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the anionic surfactant is a branched anionic surfactant having a level of branching of from about 5% to about 40%, preferably from about 10 to about 35% and more preferably from about 20% to about 30%, more preferably the branched anionic surfactant comprises more than 50% by weight thereof of an alkyl ethoxylated sulphate. Preferably the branched anionic surfactant has an average ethoxylation degree of from about 0.2 to about 3, more preferably from 0.2 to 1 and preferably an average level of branching of from about 5% to about 40%.

Preferably, the anionic surfactant comprises at least 50%, more preferably at least 60% and preferably at least 70% by weight of the anionic surfactant, more preferably the branched anionic surfactant comprises more than 50% by weight thereof of an alkyl ethoxylated sulphate having an ethoxylation degree of from about 0.2 to about 3, preferably 0.2 to 1 and preferably a level of branching of from about 5% to about 40%.

### Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial-Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

### Sulphonate Surfactants

Suitable sulphonate surfactants for use herein include water-soluble salts of C8-C18 alkyl or hydroxyalkyl sulphonates, C11-C18 alkyl benzene sulphonates (LAS), modified alkylbenzene sulphonate (MLAS), methyl ester sulphonate (MES) and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic surfactant, when present, is comprised in an amount of less than 2%, preferably less than 1% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

### Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y— (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a Cl-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹13 N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id) in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetain.

### Amphiphilic Alkoxylated Polyalkyleneimine Polymer

### Amphiphilic Alkoxylated Polyalkyleneimine

The composition of the invention comprises from about 0.1% to about 2%, preferably from about 0.3% to about 1.5% by weight of the composition of an amphiphilic alkoxylated polyalkyleneimine, preferably an amphiphilic polyethyleneimine polymer. Amphiphilic alkoxylated polyethyleneimine polymers will comprise ethoxy (EO) and/or propoxy (PO) and/or butoxy (BO) groups within their alkoxylation chains. Preferred amphiphilic alkoxylated polyethylene polymers comprise EO and PO groups within their alkoxylation chains. Hydrophilic alkoxylated polyethyleneimine polymers solely comprising ethoxy (EO) units within the alkoxylation chain are outside the scope of this invention.

The amphiphilic alkoxylated polyethyleneimine polymer of the composition of the invention has a polyethyleneimine backbone having from about 400 to about 5,000 weight average molecular weight, preferably from about 400 to about 2,000 weight average molecular weight, even more preferably from about 400 to about 1,000 weight average molecular weight, most preferably about 600 weight average molecular weight.

The alkoxylation chains within the amphiphilic alkoxylated polyethyleneimine polymer of the present composition have from about 400 to about 3,000 weight average molecular weight, preferably from about 600 to about 2,500 weight average molecular weight, more preferably from about 750 to about 1,000 weight average molecular weight, most preferably about 850 weight average molecular weight per alkoxylated chain.

The amphiphilic alkoxylated polyethyleneimine polymer of the present composition have from about 8,000 to about 40,000 weight average molecular weight, preferably from about 9,000 to about 30,000 weight average molecular weight, more preferably from about 10,000 to about 15,000 weight average molecular weight.

The alkoxylation of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification, wherein the terminal alkoxy moiety of the alkoxylation modification is capped with hydrogen, a C₁-C₄ alkyl or mixtures thereof; or (2) an addition of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C₁-C₄ alkyl or mixtures thereof, preferably hydrogen; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

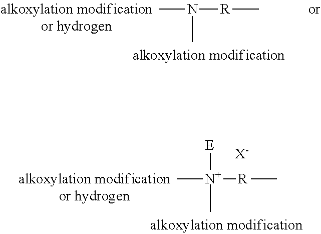

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion.

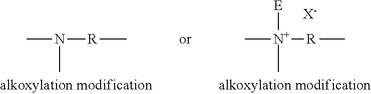

The alkoxylation modification of the polyethyleneimine backbone consists of the replacement of a hydrogen atom by a polyalkoxylene chain having an average of about 1 to about 50 alkoxy moieties, preferably from about 5 to about 40 alkoxy moieties, most preferably from about 10 to about 20 alkoxy moieties. The alkoxy moieties are selected from ethoxy (EO), propoxy (PO),butoxy (BO), and mixtures thereof. Alkoxy moieties solely comprising ethoxy units are outside the scope of the invention though. Preferably, the polyalkoxylene chain is selected from ethoxy/propoxy block moieties. More preferably, the polyalkoxylene chain is ethoxy/propoxy block moieties having an average degree of ethoxylation from about 3 to about 25 and an average degree of propoxylation from about 1 to about 20, more preferably ethoxy/propoxy block moieties having an average degree of ethoxylation from about 5 to about 15 and an average degree of propoxylation from about 5 to about 10.

More preferably the ethoxy/propoxy block moieties have a relative ethoxy to propoxy unit ratio between 3 to 1 and 1 to 1, preferably between 2 to 1 and 1 to 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Most preferably the degree of quaternization is 0%.

A preferred polyethyleneimine has the general structure of formula (I):

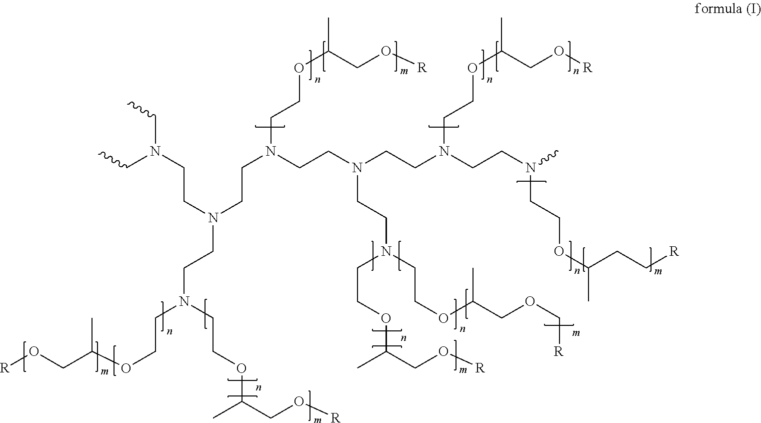

wherein the polyethyleneimine backbone has a weight average molecular weight of about 600, n of formula (I) has an average of about 10, m of formula (I) has an average of about 7 and R of formula (I) is selected from hydrogen, a C₁-C₄ alkyl and mixtures thereof, preferably hydrogen. The degree of permanent quaternization of formula (I) may be from 0% to about 22% of the polyethyleneimine backbone nitrogen atoms. The molecular weight of this polyethyleneimine preferably is between 10,000 and 15,000.

An alternative polyethyleneimine has the general structure of formula (I) but wherein the polyethyleneimine backbone has a weight average molecular weight of about 600, n of formula (I) has an average of about 24, m of formula (I) has an average of about 16 and R of formula (I) is selected from hydrogen, a C₁-C₄ alkyl and mixtures thereof, preferably hydrogen. The degree of permanent quaternization of formula (I) may be from 0% to about 22% of the polyethyleneimine backbone nitrogen atoms. The molecular weight of this polyethyleneimine preferably is between 25,000 and 30,000.

Most preferred polyethyleneimine has the general structure of formula (I) wherein the polyethyleneimine backbone has a weight average molecular weight of about 600, n of formula (I) has an average of about 10, m of formula (I) has an average of about 7 and R of formula (I) is hydrogen. The degree of permanent quaternization of formula (I) is 0% of the polyethyleneimine backbone nitrogen atoms. The molecular weight of this polyethyleneimine preferably is about from about 12,200 to 12,600.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, as described in more detail in WO 2007/135645.

### Organic Solvents

The present compositions may optionally comprise an organic solvent. Suitable organic solvents include C₄₋₁₄ ethers and diethers, polyols, glycols, alkoxylated glycols, C₆-C₁₆ glycol ethers, alkoxylated aromatic alcohols, aromatic alcohols, aliphatic linear or branched alcohols, alkoxylated aliphatic linear or branched alcohols, alkoxylated C₁-C₅ alcohols, C₈-C₁₄ alkyl and cycloalkyl hydrocarbons and halohydrocarbons, and mixtures thereof. Preferably the organic solvents include alcohols, glycols, and glycol ethers, alternatively alcohols and glycols. In one embodiment, the liquid detergent composition comprises from 0% to less than 50% of a solvent by weight of the composition. When present, the liquid detergent composition will contain from 0.01% to 20%, alternatively from 0.5% to 15%, alternatively from 1% to 10% by weight of the liquid detergent composition of said organic solvent. Non-limiting examples of specific solvents include propylene glycol, polypropylene glycol, propylene glycol phenyl ether, ethanol, and combinations thereof. In one embodiment, the composition comprises from 0.01% to 20% of an organic solvent by weight of the composition, wherein the organic solvent is selected from glycols, polyalkyleneglycols, glycol ethers, ethanol, and mixtures thereof.

### Hydrotrope

The liquid detergent compositions optionally comprises a hydrotrope in an effective amount, i.e. from 0% to 15%, or from 0.5% to 10%, or from 1% to 6%, or from 0.1% to 3%, or combinations thereof, so that the liquid dish detergent compositions are compatible or more compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. In one embodiment, the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. In one embodiment, an isotropic dish detergent composition is provided. In one embodiment, the composition comprises 0.1% to 3% of a hydrotrope by weight of the composition, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

The detergent composition herein may comprise a number of optional ingredients such as builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters such as salt especially NaCl, and pH adjusters and buffering means.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

### EXAMPLES

### Example 1

The following liquid detergent compositions were prepared by mixing the individual raw materials:

| % active by weight | Comparative | Comparative | Comparative | Comparative | |
|---|---|---|---|---|---|
| of the composition | example A | example B | example C | example D | Example A |
| Code | 4.4 | 2.85 | 2.85 + C10 | 2.85 + PEI | 2.85 + |
| | | | | | C10 + |
| | | | | | PEI |
| C1213 alkyl ethoxy | 25.1% | 22.8% | 22.8% | 22.8% | 22.8% |
| (0.6) sulfate (AES) | | | | | |
| C1214 dimethyl | 5.7% | 8.0% | 7.0% | 8.0% | 7.0% |
| amine oxide | | | | | |
| C10 dimethyl | — | — | 1.0% | — | 1.0% |
| amine oxide | | | | | |
| AES/Total Amine | 4.4 | 2.85 | 2.85 | 2.85 | 2.85 |
| Oxide - wt % ratio | | | | | |
| Lutensol XP80 | 0.45% | 0.45% | 0.45% | 0.45% | 0.45% |
| PEI600EO₁₀PO₇ | — | — | — | 0.8% | 0.8% |
| NaCl | 1.2% | 1.2% | 1.2% | 1.2% | 1.2% |
| Polypropyleneglycol | 0.8% | 0.8% | 0.8% | 0.8% | 0.8% |
| (MW 2000) | | | | | |
| Ethanol | 5.6% | 5.4% | 5.7% | 4.9% | 5.0% |
| pH (10% dilution | 9 | 9 | 9 | 9 | 9 |
| in demi water at | | | | | |
| 20° C.) - with | | | | | |
| NaOH | | | | | |
| Water and minors | To 100% | To 100% | To 100% | To 100% | To 100% |
| (dye, perfume, | | | | | |
| preservative) | | | | | |

C1213 alkyl ethoxy (0.6) sulfate (AES): C12-13 alkyl ethoxy sulfate with an average degree of ethoxylation of 0.6

Lutensol XP80: Non-ionic surfactant available from BASF

PEI600EO10PO7: Polyethyleneimine backbone with MW about 600, comprising EO—terminal PO block polyalkoxylate side chains comprising each on average 10 EO and 7 PO units and hydrogen capped, MW 12,417.

Aqueous solutions were made by diluting the composition with demineralized water at different levels of dilution. The viscosity of the resulting solutions is plotted versus the product concentration (expressed as weight per cent of the solution). Viscosities were measured at 20° C. on Brookfield V5 instrument using a spindle 31. The RPM were modified depending on the actual viscosity to have a torque between 40 and 50%.

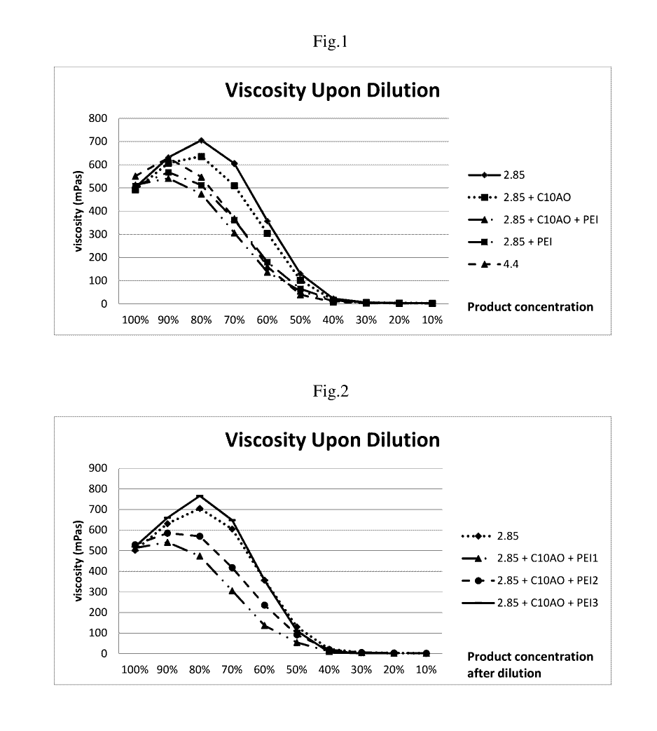

It can be seen from FIG. 1 that by increasing the relative mid-cut amine oxide to AES content (Comparative example A to Comparative example B) that the product undergoes an undesired thickening upon dilution, while Example A according to the invention, comprising both low cut amine oxide (C10 dimethyl amine oxide) as well as an amphiphilic alkoxylated polyethyleneimine has the more desired thinning upon dilution. A product that thickens upon dilution will inhibit the initial foam generation upon squeezing a sponge during a consumer use.

This was confirmed by a foaming test which was conducted to assess the initial foam properties of the comparative examples compared to the example according to the invention. The data in the table below clearly shows that Example A having the C10 dimethyl amine oxide and alkoxylated polyethyleneimine combination according to the invention, has a significant higher initial foam profile compared to the comparative examples which do not have this C10 dimethyl amine oxide and alkoxylated polyethyleneimine combination.

| | Comparative | Comparative | Comparative | |
|---|---|---|---|---|
| | Example B | Example C | Example D | Example A |
| Code | 2.85 | 2.85 + C10 | 2.85 + PEI | 2.85 + C10 + |
| | | | | PEI |
| Initial | 100 | 110 | 110 | 123s |
| foam | | | | |

Initial Foam Volume Test Protocol:

25 g of demineralized water at 30° C. is soaked in a sponge (Type: Sumitomo 3M (Japan)—code S—21K−Size=cut to 7.5×5.75×3.0 cm). 0.5 g of the tested product is placed on the center of the soft side of the sponge (opposite side of scrubbing side).

While wearing latex lab gloves, the sponge is manually squeezed 5 times with maximum power while holding soft-side up, at a speed of 80 squeezes per minute, as guided by a metronome. On the 5th squeeze, the fist is kept closed and the foam is collected as much as possible with a spatula into a 100 ml cone shape measuring cup and the total foam volume is measured. 2.5 ml of water at 30° C. is added to the sponge and spread equally over the soft side using a 3 ml plastic syringe. 10 drops of soy bean oil (Wako: Cat# 190-03776) are spread equally over the soft side of the sponge using a 2 ml dropper. The sponge is again manually squeezed 5 times with maximum power while holding soft-side up at a speed of 80 squeezes per minute. On the 5th squeeze, the fist is kept closed and the foam is again collected as much as possible with a spatula into a separate 100 ml cone shape measuring cup and the total foam volume is measured. The amount of foam of the first and second measurement are added up. The test is executed by 3 different trained operators, replicating twice each test sample. The average foam volume of the 6 runs is recorded as initial foam volume, and reported as an initial foam volume index versus a reference product:

initial foam volume index test product=(initial foam volume test product/initial foam volume reference product)*100

### Example 2

The following liquid detergent compositions have been prepared through mixing of the individual raw materials. The examples comprise C10 dimethyl amine oxide and solely differ in the type of alkoxylated polyethyleneimine. While Example A and B comprise an amphiphilic alkoxylated polyethyleneimine comprising both ethoxy (EO) and propoxy (PO) units, Example C comprises a hydrophilic alkoxylated polyethyleneimine solely comprising EO units. Comparative Example B comprises no alkoxylated polyethyleneimine nor C10 dimethyl amine oxide.

| % active by weight | Comparative | | | |
|---|---|---|---|---|
| of the composition | example B | Example A | Example B | Example C |
| Code | 2.85 | 2.85 + C10 + | 2.85 + C10 + | 2.85 + C10 + |
| | | PEI1 | PEI2 | PEI3 |
| C1213 alkyl ethoxy | 22.8% | 22.8% | 22.8% | 22.8% |
| (0.6) sulfate (AES) | | | | |
| C1214 dimethyl | 8.0% | 7.0% | 7.0% | 7.0% |
| amine oxide (AO) | | | | |
| C10 dimethyl amine | — | 1.0% | 1.0% | 1.0% |
| oxide (AO) | | | | |
| AES/Total AO - | 2.85 | 2.85 | 2.85 | 2.85 |
| wt % ratio | | | | |
| Lutensol XP80 | 0.45% | 0.45% | 0.45% | 0.45% |
| PEI600EO₁₀PO₇ | — | 0.8% | — | — |
| PEI600EO₂₄PO₁₆ | — | — | 0.8% | — |
| PEI600EO₂₀ | — | — | — | 0.8% |
| NaCl | 1.2% | 1.2% | 1.2% | 1.2% |
| Polypropyleneglycol | 0.8% | 0.8% | 0.8% | 0.8% |
| (MW 2000) | | | | |
| Ethanol | 5.4% | 5.0% | 5.0% | 5.0% |
| pH (10% dilution in | 9 | 9 | 9 | 9 |
| demi water at 20° C.) - | | | | |
| with NaOH | | | | |
| Water and minors | To 100% | To 100% | To 100% | To 100% |
| (dye, perfume, | | | | |
| preservative | | | | |

PEI600EO10PO7: Polyethyleneimine backbone with MW about 600, comprising EO—terminal PO block polyalkoxylate side chains comprising each on average 10 EO and 7 PO units and hydrogen capped, MW 12417.

PEI600EO24PO16: Polyethyleneimine backbone with MW about 600, comprising EO—terminal PO block polyalkoxylate side chains comprising each on average 24 EO and 16 PO units and hydrogen capped, MW 28000.

PEI600EO20: Polyethyleneimine backbone with MW about 600, comprising EO block polyalkoxylate side chains comprising each on average 20 EO units and hydrogen capped, MW12600.

Aqueous solutions were made by diluting the composition with demineralized water at different levels of dilution. The viscosity of the resulting solutions is plotted versus the product concentration (expressed as weight per cent of the solution). Viscosities were measured at 20° C. on Brookfield V5 instrument using a spindle 31. The RPM were modified depending on the actual viscosity to have a torque between 40 and 50%.

It can be seen from FIG. 2 that amphiphilic alkoxylated polyethyleneimine comprising EO and PO units (Examples A and B) show an improved viscosity upon dilution profile when formulated together with C10 dimethyl amine oxide, while hydrophilic alkoxylated polyethyleneimine solely comprising EO units (Example C) worsen the viscosity upon dilution profile even when formulated together with C10 dimethyl amine oxide. Lower molecular weight amphiphilic alkoxylated polyethyleneimine (Example A) are preferred over higher molecular weight amphiphilic alkoxylated polyethyleneimine (Example B).

What is claimed is:

1. A method of manually washing dishware comprising the steps of:
i) delivering a detergent composition in its neat form onto the dishware or a cleaning implement;
ii) cleaning the dishware with the detergent composition in the presence of water; and
iii) optionally rinsing the dishware
wherein the detergent composition comprises anionic surfactant and amine oxide surfactant in a ratio of from about 4:1 to about 1:1 and wherein the amine oxide surfactant comprises:
a) from about 5% to about 40% by weight of the amine oxide of low-cut amine oxide of formula R1R2R3AO wherein R1 and R2 are selected from hydrogen, C1-C4 alkyls and mixtures thereof and wherein R3 is selected from C10 alkyls and mixtures thereof; and
b) from about 60% to about 95% by weight of the amine oxide of mid-cut amine oxide of formula R4R5R6AO wherein R4 and R5 are selected from hydrogen, C1-C4 alkyls and mixtures thereof and wherein R6 is selected from C12-C16 alkyls and mixtures thereof
and an amphiphilic alkoxylated polyalkyleneimine wherein the amphiphilic alkoxylated polyalkyleneimine is an alkoxylated polyethyleneimine polymer comprising a polyethyleneimine backbone having from about 400 to about 5,000 weight average molecular weight and the alkoxylated polyethyleneimine polymer further comprises:
(1) one or two alkoxylation modifications per nitrogen atom by a polyalkoxylene chain having an average of about 1 to about 50 alkoxy moieties per modification, wherein the terminal alkoxy moiety of the alkoxylation modification is capped with hydrogen, a C₁-C₄ alkyl or mixtures thereof;
(2) an addition of one C₁-C₄ alkyl moiety and one or two alkoxylation modifications per nitrogen atom by a polyalkoxylene chain having an average of about 1 to about 50 alkoxy moieties per modification wherein the terminal alkoxy moiety is capped with hydrogen, a C₁-C₄ alkyl or mixtures thereof; or
(3) a combination thereof; and
wherein the alkoxy moieties comprises ethoxy (EO) and/or propoxy (PO) and/or butoxy and wherein when the alkoxylation modification comprises EO it also comprises PO or BO.

2. A method according to claim 1 wherein the weight average molecular weight per polyalkoxylene chain is from about 400 to about 8,000.

3. A method according to claim 1 wherein the weight average molecular weight of the alkoxylated polyethyleneimine is from about 8,000 to about 40,000.

4. A method according to claim 1 wherein the polyalkoxylene chain comprises a propoxy moiety in a terminal position.

5. A method according to claim 1 wherein the polyalkoxylene chain comprises ethoxy and propoxy moieties in a ratio of 1:1 to 2:1.

6. A method according to claim 1 wherein the number of ethoxy moieties of a polyalkoxylene chain is from about 22 to about 26, and the number of propoxy moieties is from about 14 to about 18 and the polyalkoxylene chain is free of butoxy moieties.

7. A method according to claim 1 wherein the number of ethoxy moieties of a polyalkoxylene chain is from about 8 to about 12, and the number of propoxy moieties is from about 5 to about 9 and the polyalkoxylene chain free of butoxy moieties.

8. A method according to claim 1 wherein R3 is n-decyl and R1 and R2 are both methyl.

9. A method according to claim 1 comprising from about 3 to about 15% by weight of the composition of the amine oxide surfactant wherein the amine oxide surfactant comprises
a) from about 5% to about 30% by weight of the amine oxide of the low-cut amine oxide wherein R1 and R2 are both methyl and R3 is n-decyl;
b) from about 70% to about 90% by weight of the amine oxide of the mid-cut amine oxide.

10. A method according to claim 1 comprising less than about 5%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof.

11. A method according to claim 1 wherein the composition comprises from about 0.1 to about 2% by weight of the composition of the alkoxylated polyalkyleneimine.

12. A method according to claim 1 further comprising a poly propylene glycol having a molecular weight greater than 1,000.

13. A method according to claim 1 wherein the composition comprises sodium chloride.

14. A method according to claim 1 wherein the composition comprises ethanol.

15. A method according to claim 1 wherein the composition comprises sodium cumene sulfonate.

16. A method according to claim 1 wherein the anionic surfactant comprises an alkyl alkoxylated anionic surfactant having an average alkoxylation degree of from about 0.2 to about 3 preferably

17. A method according to claim 1 wherein the amount of anionic surfactant is from about 10% to about 40% by weight of the composition.

18. A method according to claim 1 wherein the weight ratio of the anionic surfactant to the amine oxide surfactant is from about 3:1 to about 2.5:1.

19. A method according to claim 1 wherein the composition comprises from about 0.1% to about 2% by weight of the composition of non ionic surfactant.

20. A method of generating flash suds comprising the step of adding
i) a low-cut amine oxide of formula R1R2R3AO wherein R1 and R2 are selected from hydrogen, C1-C4 alkyls and mixtures thereof and wherein R3 is selected from C10 alkyls and mixtures thereof; and
ii) an amphiphilic alkoxylated polyalkyleneimine
in a hand dishwashing composition comprising anionic surfactant and amine oxide surfactant in a ratio of from about 4:1 to about 1:1.
